(19) United States
(12) Patent Application Publication
(10) Pub. No.: US 2013/0175828 A1
(43) Pub. Date: Jul. 11, 2013

(54) FRAME FOR A RECREATIONAL VEHICLE

(71) Applicant: BASF SE, Ludwigshafen (DE)

(72) Inventors: Joseph F. White, Holland, MI (US); Phillip E. Wilson, Northville, MI (US)

(73) Assignee: BASF SE, Ludwigshafen (DE)

(21) Appl. No.: 13/734,102

(22) Filed: Jan. 4, 2013

Related U.S. Application Data
(60) Provisional application No. 61/583,470, filed on Jan. 5, 2012.

(51) Int. Cl. B62D 27/02; B62D 25/04; B62D 25/06

(52) U.S. Cl. CPC B62D 27/02; B62D 25/06; B62D 25/04
USPC 296/203.03; 296/102

(57) ABSTRACT

A roof frame assembly for a recreational comprises a rail extending along an axis. The rail is configured to support a roof of the recreational vehicle on a wall frame of the recreational vehicle. A plurality of beams extend transversely to the rail and are spaced from each other along the axis. The beams are configured to support the roof of the recreational vehicle. A plurality of mounting blocks are spaced from each other along the axis with the mounting blocks disposed between and engaged to the rail and the beams. The mounting blocks support the beams on the rail and are formed of a polymeric material. Each mounting block includes a rail attachment configured to engage the rail and a beam attachment configured to engage one of the beams.

### CROSS-REFERENCE TO RELATED APPLICATIONS

The subject patent application claims priority to and all the benefits of U.S. Provisional Patent Application Ser. No. 61/583,470 which was filed on Jan. 5, 2012, the entire specification of which is expressly incorporated herein by reference.

### BACKGROUND

1. Field of the Invention

The present invention relates a frame for a recreational vehicle. For example, the frame includes a roof frame assembly and/or a wall frame assembly.

2. Description of the Related Art

Recreational vehicles are popular among vacationers who enjoy driving/transporting the recreational vehicle to various locations. The recreational vehicle typically includes interior quarters that house, for example, furniture, beds, kitchen areas, bathrooms, etc. A wide variety of recreational vehicles exist including motor homes, pop-up campers, truck campers, etc., to name only a few. The recreational vehicle can be self-propelled, e.g., can include the interior quarters integrally designed with a driver's cabin, engine, etc., or can be attached to and pulled by another vehicle.

The recreational vehicle includes a frame for defining the interior quarters and for supporting exterior features of the recreational vehicle. The frame can include a roof frame assembly that supports a roof of the recreational vehicle and a ceiling of the interior quarters. The frame can also include a wall frame assembly that supports an exterior wall of the recreational vehicle and an interior wall of the interior quarters. The roof frame assembly and the wall frame assembly can also support insulation, wiring, and other features of the recreational vehicle.

The design of the frame of recreational vehicles is bulky and complex. The frame of the recreational vehicle accounts for a significant proportion of weight of the recreational vehicle. Increased weight not only creates difficulty during assembly of the frame, but also disadvantageously decreases fuel economy when the recreational vehicle is driven/transported. In addition, the construction of this bulky and complex design of the frame is expensive and time consuming. For example, the current design requires expensive and time consuming manufacturing processes such as machining, stamping, and welding.

Also, current designs of the frame require additional components and manufacturing steps to fully assemble the frame. As just a few examples, additional components must be added to the frame to achieve rounded corners on window openings, as is customary in recreational vehicles, and to achieve the proper roof shapes and dimensions.

Accordingly, there remains opportunity to design and manufacture an improved frame for a recreational vehicle.

### SUMMARY AND ADVANTAGES

The present invention includes a roof frame assembly for a recreational vehicle having a roof and a wall frame. The roof frame assembly comprises a rail extending along an axis and configured to support the roof on the wall frame. A plurality of beams extend transversely to the rail and are spaced from each other along the axis and are configured to support the roof of the recreational vehicle. A plurality of mounting blocks are spaced from each other along the axis with the mounting blocks disposed between and engaged to the rail and the beams and supporting the beams on the rail. The mounting blocks are formed of a polymeric material. Each of the mounting blocks include a rail attachment configured to engage the rail and a beam attachment configured to engage one of the beams.

The mounting blocks are configured to engage the rail and the beam. Yet the mounting blocks are spaced from each other for a simplified design and a reduction in weight. In addition, the roof frame assembly is easily assembled since the spaced mounting blocks engage the rail and the beam. In addition, the weight of the roof frame assembly is advantageously reduced by forming the mounting blocks from a polymeric material. This weight savings advantageously increases the fuel economy of the recreational vehicle and allows for simplified and more fuel efficient assembly processes for assembling the roof frame assembly.

The present invention also includes a wall frame assembly for supporting a wall of a recreational vehicle. The wall frame assembly comprises a first post and a second post spaced from each other for extending vertically between a floor and a roof of the recreational vehicle to support the wall of the recreational vehicle. A pair of cross-members are spaced from each other and each extend between the first post and the second post to define a window opening. A pair of connectors are spaced from each other along the first post and are disposed between and connect the pair of cross-members and the first post. The pair of connectors are spaced from each other along the second post with the connectors disposed between and connecting the pair of cross-members and the second post. Each of the connectors include a post attachment configured to engage either of the first post and the second post and each of the connectors include a cross-member attachment configured to engage either of the pair of cross-members such that the connectors are interchangeable with each other.

The wall frame assembly has a simplified design due to the interchangeability of the connectors. Since the connectors are interchangeable, the manufacturing of the connectors is simplified in that only a single set of tools can produce all of the connectors. In addition, assembly of the wall frame assembly is simplified because any connector can be used with any post thus eliminating any extra precautions necessary to ensure that the proper connector is assembled to the proper post.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a recreational vehicle;

FIG. 2 is a cut-away view of the recreational vehicle including an embodiment of the roof frame assembly;

FIG. 3 is a cut-away view of a portion of the recreational vehicle including the embodiment of the roof frame assembly of FIG. 2;

FIG. 4 is a cut-away view of a portion of the recreational vehicle including another embodiment of the roof frame assembly;

FIG. 5 is a cut-away view of a portion of the recreational vehicle including yet another embodiment of the roof frame assembly;

FIG. 6 is a front view of a portion of an embodiment of a wall frame assembly;

FIG. 7 is an exploded view of a portion of the embodiment of the wall frame assembly of FIG. 6;

FIG. 8 is an exploded view of a portion of another embodiment of the wall frame assembly;

FIG. 9A is an exploded view of a portion a post of a wall frame assembly, a rail of a roof frame assembly, and an embodiment of an intermediate member for connecting the post and the rail;

FIG. 9B is an assembled view of the components of FIG. 9A; and

FIG. 10 is an exploded view of a wall frame assembly, a rail of a roof frame assembly, and another embodiment of an intermediate member for connecting the post and the rail.

### DETAILED DESCRIPTION OF THE INVENTION

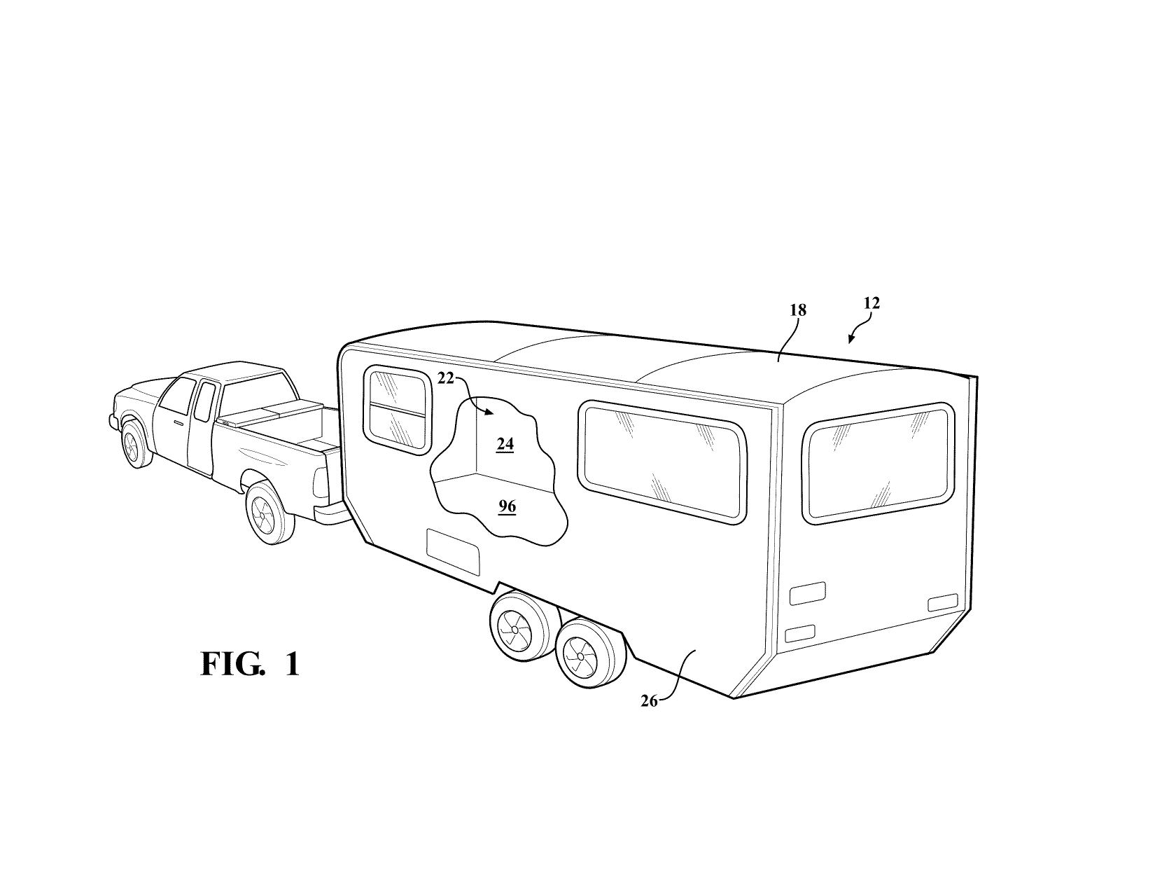

Referring to the Figures, wherein like numerals indicate like parts throughout the several views, a frame 10 of a recreational vehicle 12 is generally shown. The recreational vehicle 12 shown in FIG. 1 is a type of recreational vehicle 12 typically referred to as a fifth-wheel trailer. However, it should be appreciated that the recreational vehicle 12 can be any type of recreational vehicle such as, for example, a motor home, a pop-up camper, a truck camper, etc., without departing from the nature of the present invention. With reference to FIG. 1, the frame 10 of the recreational vehicle 12 defines interior quarters 22 of the recreational vehicle 12.

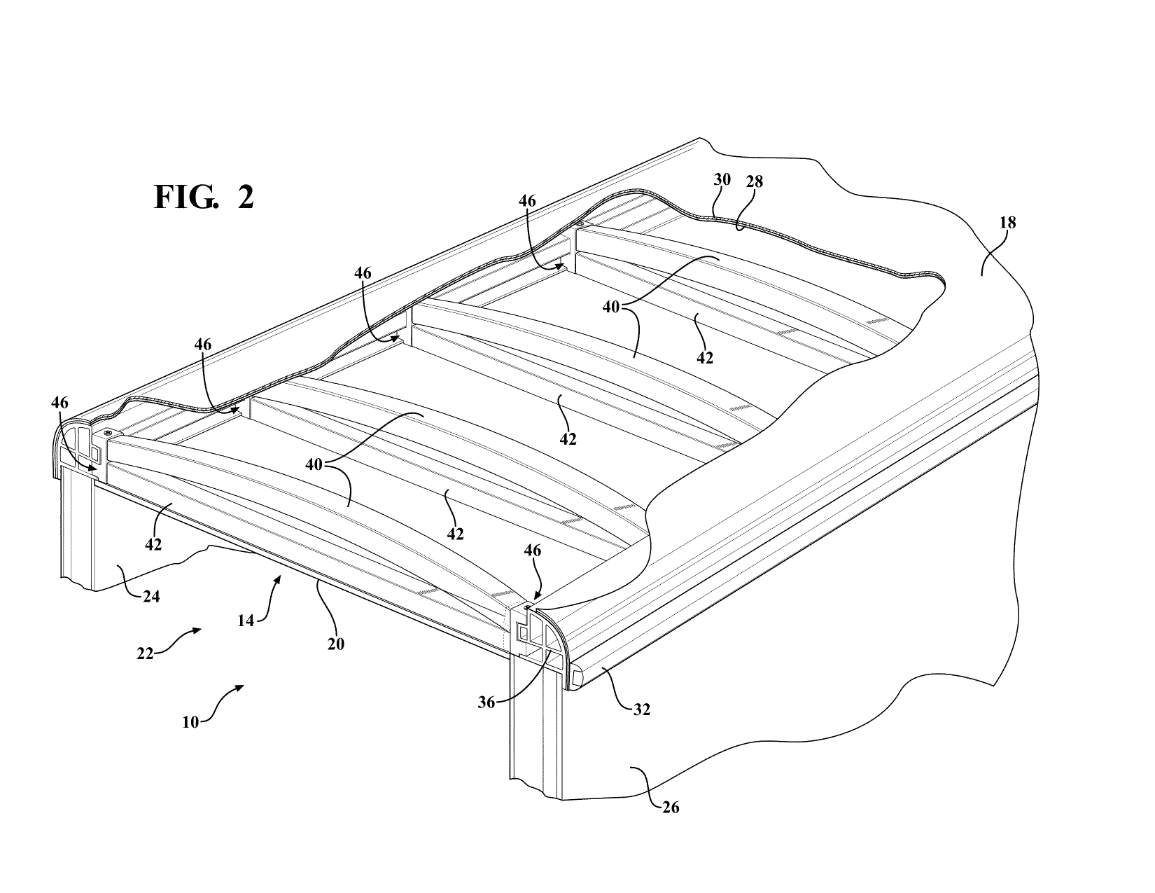

The frame 10 includes a roof frame assembly 14 and a wall frame 16, also referred to herein as wall frame assembly 16, for the recreational vehicle 12. With reference to FIGS. 1 and 2, the roof frame assembly 14 supports a roof 18 of the recreational vehicle 12 and typically supports a ceiling 20 of the interior quarters 22 of the recreational vehicle 12. The wall frame assembly 16 supports a wall 24 of the interior quarters 22 of the recreational vehicle 12 and typically supports an exterior wall 26 of the recreational vehicle 12.

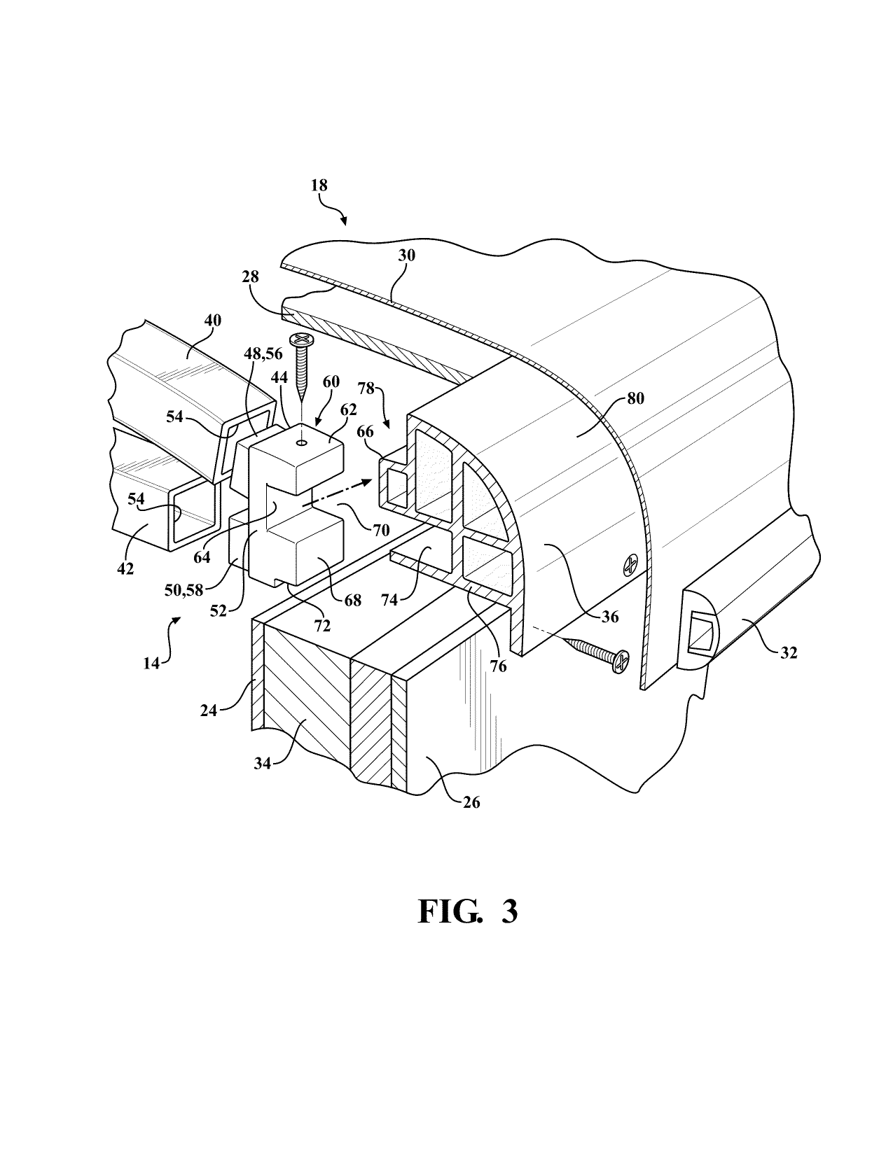

The roof 18 typically includes sheeting 28 covering the interior quarters 22. The sheeting 28 can be, for example, wood sheeting such as plywood, particle board, etc., but can be any type of material without departing from the nature of the present invention. The roof 18 can also include a covering 30 that covers the sheeting 28. The covering 30 is typically flexible to accommodate contours of the rest of the roof 18. The covering 30 can be, for example, rubber, plastic, etc., and combinations and/or layers thereof. A cap 32 can, for example, be affixed to the covering 30 and the exterior wall 26 to connect the covering 30 to the rest of the recreational vehicle 12, as shown in FIGS. 2 and 3. In the alternative, or in addition, a corner member 33, which is typically relatively rigid relative to the covering 30, can be mounted to the roof 18 and the exterior wall 26 to mount the covering 30 to the roof 18.

The ceiling 20 and the wall 24 of the interior quarters 22 can be formed from the same or from different material. The ceiling 20 and the wall 24 can be, for example, formed from wood sheeting, wood paneling (such as luaun), plastic paneling, etc., and combinations and/or layers thereof. The exterior wall 26 can be, for example, formed from plastic paneling, metal paneling, etc., and combinations and/or layers thereof. Insulation 34 is typically disposed between the wall 24 and the exterior wall 26.

FIGS. 2-3, FIG. 4, and FIG. 5, include three different embodiments of the roof frame assembly 14. The embodiments of the roof frame assembly 14 of FIGS. 2 and 3, FIG. 4, and FIG. 5 are shown merely for exemplary purposes and it should be appreciated that features of these embodiments of the roof frame assembly 14 can be interchanged without departing from the nature of the present invention. Features common to the different embodiments are identified with common numerals in the Figures.

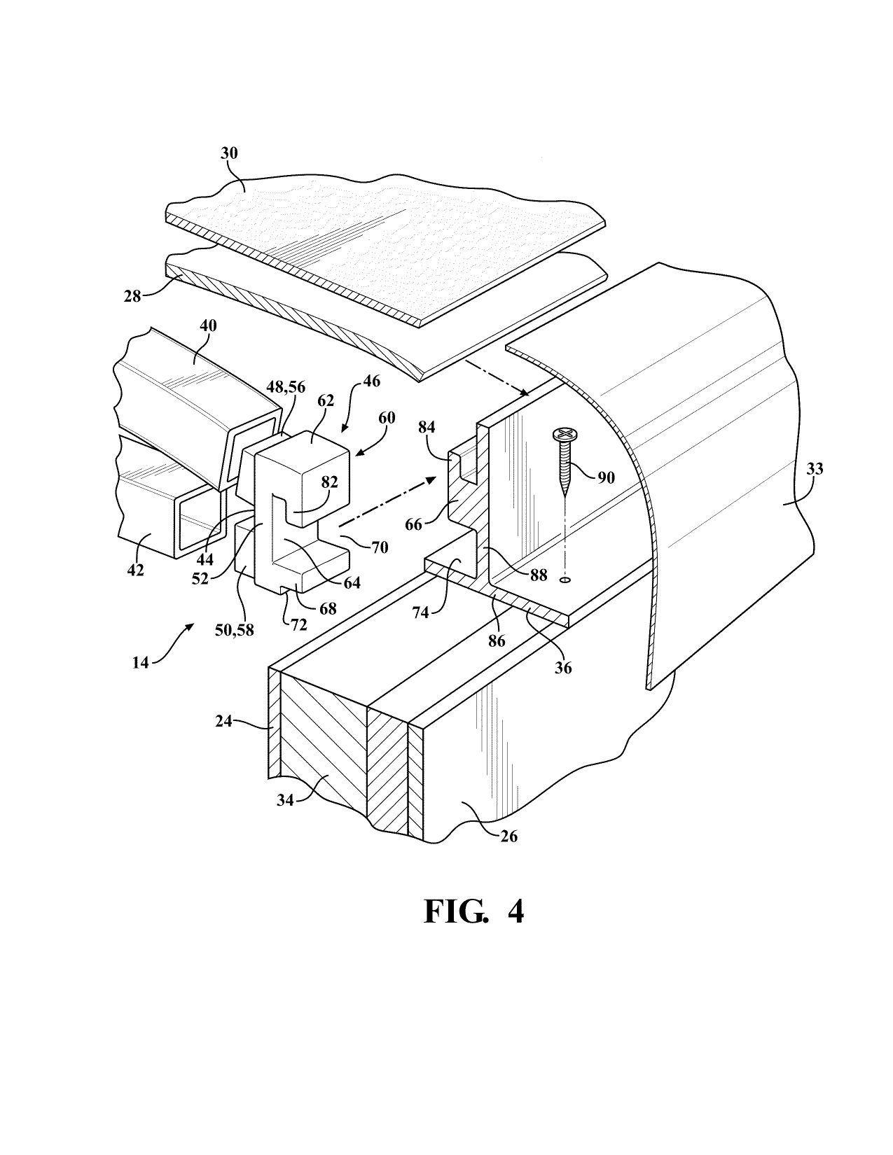

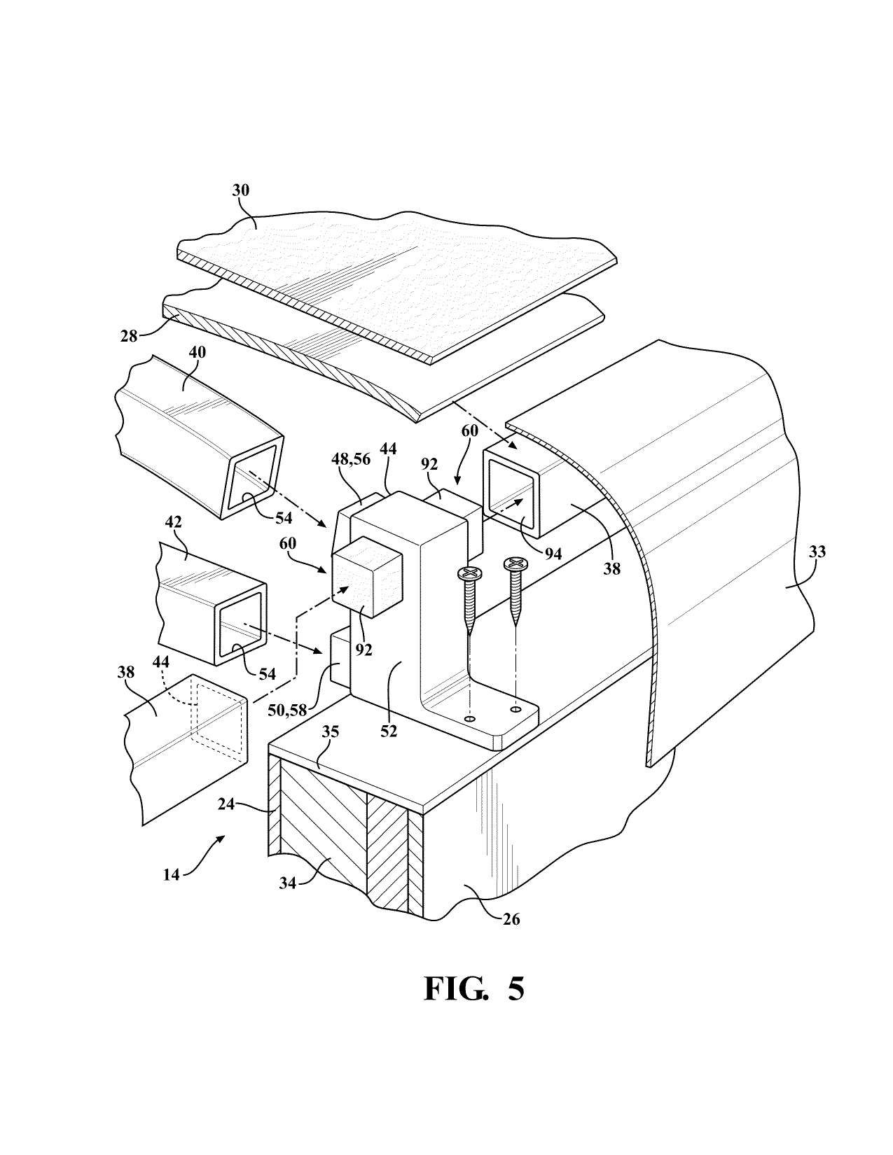

The roof frame assembly 14 includes a rail 36 extending along an axis A. As best shown in FIG. 2, the roof frame assembly 14 typically includes a pair of rails 36 extending in parallel with each other. It should be appreciated that, although not shown in the Figures, the embodiments of the roof frame assembly 14 of FIG. 4 and FIG. 5 also include a pair of rails 36. The rail 36 is typically coupled to the wall frame assembly 16. The rail 36 can, for example, be continuous, as shown in FIGS. 2-4, or can include a plurality of segments 38 spaced from each other and extending along the axis A as shown in FIG. 5.

The roof frame assembly 14 includes a plurality of beams 40 extending transversely to the rail 36. The beams 40 extend between the pair of rails 36, as best shown in FIG. 2. The beams 40 are spaced from each other along the axis A. The beams 40 are configured to support the roof 18 of the recreational vehicle 12. In other words, the beams 40 are sized, shaped, and formed of suitable material to support the weight of the roof 18.

Lower beams 42 are aligned with the beams 40 along the axis A for supporting the ceiling 20 of the interior quarters 22. In other words, each lower beam 42 is paired with one of the upper beams 40 along the axis A. The lower beams 42 extend between the pair of rails 36, as best shown in FIG. 2. The lower beams 42 are configured to support the ceiling 20. In other words, the lower beams 42 are sized, shaped, and formed of suitable material to support the weight of the ceiling 20.

The beams 40 and lower beams 42 are typically formed of a polymeric material. The polymeric material of the beams 40 can be the same as or different than the polymeric material of the lower beams 42. For example, polymeric material of the beams 40 and lower beams 42 can be a polyamide. The polyamide can, for example, be nylon 6, nylon 6,6, nylon 6/66, etc. The polyamide can include fiber reinforcement, e.g., can be glass filled. For example, the polyamide can be 30% glass filled. In the alternative, the polymeric material of the beams 40 and the lower beams 42 can be, for example, polybutylene terephthalate (PBT) or polyethylene terephthalate (PET). As one example, the polymeric material can be a glass fiber reinforced nylon, e.g., 30% glass fiber reinforced, commercially available under the tradename Ultramid® B3EG6 from BASF Corporation of Florham Park, N.J. However, it should be appreciated that the polymeric material of the beams 40 and the lower beams 42 can be any type of polymeric material without departing from the nature of the present invention. Alternatively, the beams 40 and lower beams 42 can be metal such as, for example, aluminum.

A plurality of mounting blocks 46 are spaced from each other along the axis A with the mounting blocks 46 disposed between and engaged to the rail 36 and the beams 40 and lower beams 42. With reference to FIG. 2, it should be appreciated that the mounting blocks 46 are typically identical such that the mounting blocks 46 are interchangeable with each other.

The mounting blocks 46 are configured to engage the rail 36 for supporting the beams 40 and the lower beams 42 such that the beams 40 extend transversely to the rail 36 to support the roof 18 of the recreational vehicle 12 and the lower beams 42 extend transversely to the rail 36 to support the ceiling 20 of the recreational vehicle 12. Specifically, each of the mounting blocks 46 includes a beam attachment 48 and a lower beam attachment 50.

Each beam attachment 48 is configured to engage one of the beams 40 and each lower beam attachment 50 is configured to engage one of the lower beams 42. For example, the mounting blocks 46 each include a body 52 with the beam attachment 48 including a protrusion 56 extending from the body 52 and with the lower beam attachment 50 including a lower protrusion 58 extending from the body 52. The beam attachment 48 and the lower beam attachment 50 typically extend from a common side 44 of the body 52.

The beam 40 defines a cavity 54 configured to receive the protrusion 56 and the lower beam 42 defines a cavity 54 configured to receive the lower protrusion 58. Typically, cavities 54 of the beam 40 and the lower beam 42 are sized and shaped to receive the protrusion 56 and the lower protrusion 58, respectively, in press-fit relationship. In other words, the beam 40 and the lower beam 42 are frictionally engaged with the protrusion 56 and the lower protrusion 58, respectively. For example, as shown in FIGS. 3-5, the protrusion 56 and lower protrusion 58 are sized and shaped to be received in the cavities 54 of the beam 40 and lower beam 42, respectively, in a press-fit relationship. It should be appreciated that the shapes of the cavities 54 of the beam 42 and lower beam 44 and the shapes of the protrusion 56 and lower protrusion 58 can have any shape suitable for a press-fit relationship without departing from the nature of the present invention. Threaded fasteners (not shown), adhesive (not shown), etc., can be used to further engaged the beam 40 and lower beam 42 to the protrusion 56 and lower protrusion 58, respectively.

Each of the mounting blocks 46 includes a rail attachment 60 configured to engage the rail 36. In the first embodiment, as shown in FIGS. 2 and 3, the rail attachment 60 includes a finger 62 extending from the body 52 in an opposite direction from the protrusion 56 and lower protrusion 58, i.e., extending from an opposite side 64 of the body 52 that is opposite the common side 44. The rail 36 includes a corresponding finger 66 configured to interlock with the finger 62 of the rail attachment 60 for mounting the mounting block to the rail 36.

The mounting blocks 46 are typically formed of a first polymeric material. It should be appreciated that term “first” preceding the term “polymeric material” is used merely for identification purposes to distinguish the polymeric material of the mounting blocks 46 from other polymeric materials referenced herein. The first polymeric material of the mounting blocks 46 can be the same as or different than the polymeric material of the beams 40 and lower beams 42.

The first polymeric material of the mounting blocks 46 can be, for example, a polyamide. The polyamide can, for example, be nylon 6, nylon 6,6, nylon 6/66, etc. The polyamide can include fiber reinforcement, e.g., can be glass filled. For example, the polyamide can be 30% glass filled. In the alternative, the first polymeric material of the mounting blocks 46 can be, for example, polybutylene terephthalate (PBT) or polyethylene terephthalate (PET). As one example, the first polymeric material can be a glass fiber reinforced nylon, e.g., 30% glass fiber reinforced, commercially available under the tradename Ultramid® B3EG6 from BASF Corporation of Florham Park, N.J. However, it should be appreciated that the first polymeric material can be any type of polymeric material without departing from the nature of the present invention.

The rail 36 is typically formed of a second polymeric material. The term “second” preceding the term “polymeric material” is used merely for identification purposes to distinguish the polymeric material of the rail 36 from other polymeric materials referenced herein. The second polymeric material of the rail 36 can be the same as or different than the polymeric material of the beams 40 and the lower beams 42 and the first polymeric material of the mounting blocks 46. The rail 36 can alternatively be metal such as, for example, aluminum.

The second polymeric material of the rail 36 can be, for example, a polyamide. The polyamide can, for example, be nylon 6, nylon 6,6, nylon 6/66, etc. The polyamide can include fiber reinforcement, e.g., can be glass filled. For example, the polyamide can be 30% glass filled. In the alternative, the second polymeric material of the rail 36 can be, for example, polybutylene terephthalate (PBT) or polyethylene terephthalate (PET). As one example, the second polymeric material can be a glass fiber reinforced nylon, e.g., 30% glass fiber reinforced, commercially available under the tradename Ultramid® B3EG6 from BASF Corporation of Florham Park, N.J. However, it should be appreciated that the second polymeric material can be any type of polymeric material without departing from the nature of the present invention.

In the embodiment shown in FIGS. 2 and 3, the rail attachment 60 includes a lower finger 68 and defines a recess 70 between the finger 62 and the lower finger 68. The corresponding finger 66 of the rail 36 is sized and shaped to fit in the recess 70 to connect the mounting block to the rail 36. A threaded fastener (not shown), for example, can extend through the finger 62 and into the corresponding finger 66 to fix the mounting block to the rail 36. In addition or in the alternative, adhesive (not shown) is disposed between the finger 62 and the corresponding finger 66 to adhere the mounting block 46 to the rail 36.

With continued reference to the embodiment of FIGS. 2 and 3, each of the mounting blocks 46 presents a lower surface 72 configured to abut the rail 36 when the corresponding finger 66 interlocks with the finger 62 for supporting the mounting block 46 on the rail 36. Specifically, the lower finger 68 of the mounting block 46 presents the lower surface 72 and the rail 36 presents a ledge 74 below the corresponding finger 66 for receiving the mounting block 46 and abutting the lower surface 72.

As shown in FIGS. 2 and 3, the rail 36 can include a bottom end 76 for abutting the wall 24 or the wall frame assembly 16 of the recreational vehicle 12, an inwardly facing end 78 presenting the beam attachment 48, and a rounded exterior surface 80 curving from the inwardly facing end 78 to the bottom end 76. As shown in FIG. 2, the covering 30 of the roof 18 can extend around the rounded exterior surface 80 with the rounded exterior surface 80 supporting and providing shape for the covering 30.

In the embodiment shown in FIG. 4, the rail attachment 60 includes a flange 82 extending from the finger 62 and the rail 36 includes a corresponding flange 84 extending from the corresponding finger 66 configured to interlock with the finger 62 of the rail attachment 60 for mounting the mounting block to the rail 36. The flange 82 typically extends transversely to the finger 62. As shown in FIG. 4, for example, the flange 82 extends downwardly and the corresponding flange 84 extends upwardly to engage the flange 82.

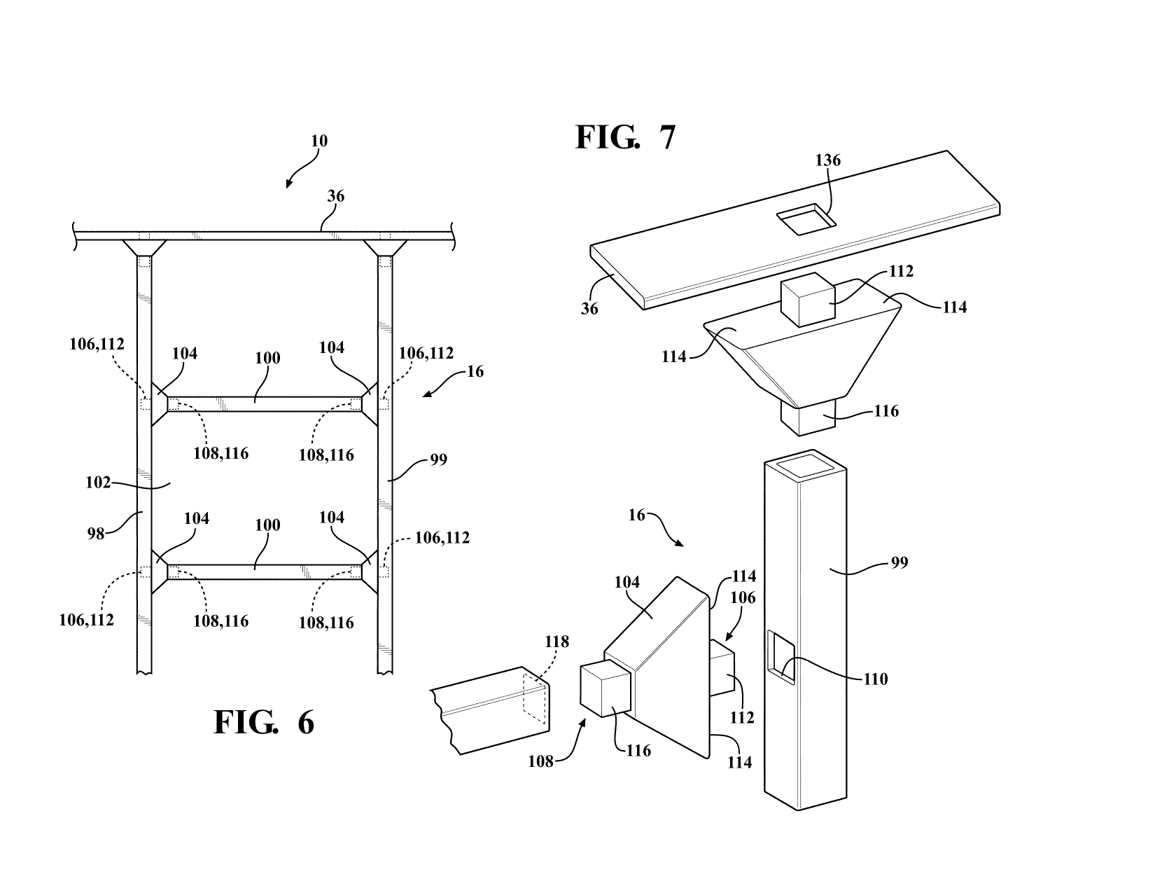

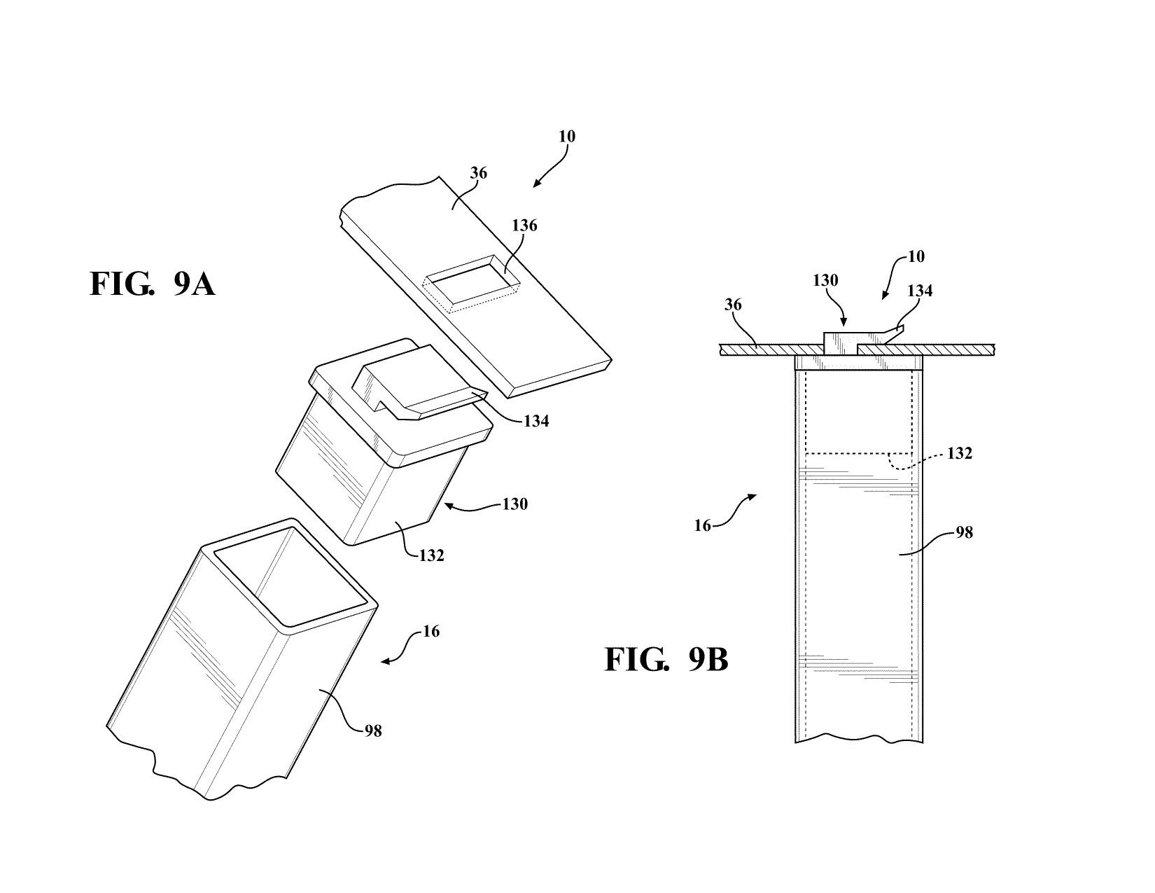

With continued reference to the embodiment shown in FIG. 4, the rail 36 can include a platform 86 and partition 88 extending upwardly from the platform 86. The platform 86 is typically mounted to the wall frame assembly 16 with, for example, a threaded fastener 90. Alternatively, for example, the mounting of the platform 86 to the wall frame assembly 16 is the same as the connection between the rail 36 and the wall frame assembly 16 shown in FIGS. 6, 9a-b, or 10. The platform 86 can, for example, support wiring (not shown) for the recreational vehicle 12.

As shown in the embodiment shown in FIG. 5, the rail 36 can include a plurality of segments 38 spaced from each other and extending along the axis A with the mounting blocks 46 disposed along the axis A between the segments 38. The mounting blocks 46 are typically mounted to a header 35 connected to the wall frame assembly 16. The header 35 and/or the mounting blocks 46 can support wiring (not shown) for the recreational vehicle 12. The plurality of segments 38 of the rail 36 can, for example, be formed of the second polymeric material.

In the embodiment shown in FIG. 5, the rail attachment 60 includes a pair of projections 92 for engaging the segments 38. The projections 92 extend from the body 52 in opposite directions. Each segment 38 of the rail 36 defines cavities 94 defined in opposing ends of the segment 38. The projections 92 and the cavities 94 are sized and shaped so that the projections 92 fit in the cavities 94 in a press-fit relationship. Fasteners (not shown) and/or adhesive (not shown) can be used to engage the projections 92 in the cavities 94.

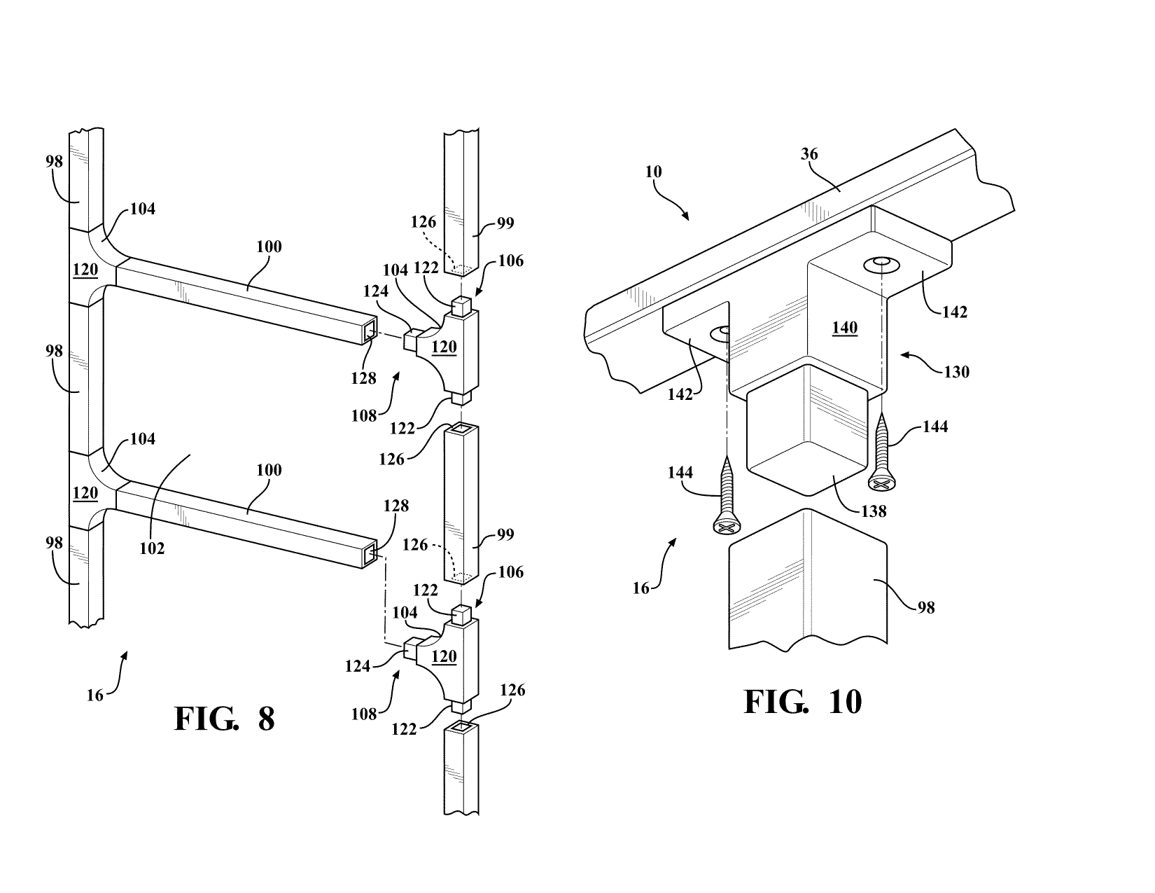

As set forth above, the wall frame assembly 16 supports the wall 24 of a recreational vehicle 12. The wall frame assembly 16 is typically mounted to and extends between a floor 96 of the recreational vehicle 12 and the ceiling 20 of the recreational vehicle 12 to support the wall 24 between the floor 96 and the ceiling 20. The wall frame assembly 16 is typically mounted to the rail 36 and to a floor frame (not shown) that supports the floor 96. One embodiment of the wall frame assembly 16 is shown in FIGS. 6 and 7 and another embodiment of the wall frame assembly 16 is shown in FIG. 8.

With reference to FIGS. 6 and 8, the wall frame assembly 16 includes posts, e.g., a first post 98 and a second post 99, spaced from each other for extending vertically between the floor 96 and the roof 18 of the recreational vehicle 12 to support the wall 24 of the recreational vehicle 12. A pair of cross-members 100 are spaced from each other and each extend between the posts 98, 99 to define a window opening 102. The window opening 102 houses a window (not numbered), as shown in FIG. 1. The posts 98, 99 and cross-members 100 can be formed of the polymeric material described above for the beams 40 and lower beams 42. Alternatively, the posts 98, 99 and the cross-members 100 can be formed of metal such as aluminum. However, it should be appreciated that the posts 98, 99 and cross-members 100 can be formed of any type of material without departing from the nature of the present invention.

With continued reference to FIGS. 6 and 8, four connectors 104 connect the posts 98, 99 and the cross-members 100. Specifically, a pair of connectors 104 are spaced from each other along the first post 98 and are disposed between and connect the pair of cross-members 100 and the first post 98. A pair of connectors 104 are spaced from each other along the second post 99 and are disposed between and connect the pair of cross-members 104 and the second post 99.

The connectors 104 can be, for example, formed of a third polymeric material. The term “third” preceding the term “polymeric material” is used merely for identification purposes to distinguish the polymeric material of the connectors 104 from other polymeric materials referenced herein. The third polymeric material of the connectors 104 can be the same as or different than the polymeric material of the beams 40 and the lower beams 42 and the first polymeric material of the mounting blocks 46, and the second polymeric material of the rail 36.

The third polymeric material of the connectors 104, for example, can be a polyamide. The polyamide can, for example, be nylon 6, nylon 6,6, nylon 6/66, etc. The polyamide can include fiber reinforcement, e.g., can be glass filled. For example, the polyamide can be 30% glass filled. In the alternative, the third polymeric material of the connectors 104 can be, for example, polybutylene terephthalate (PBT) or polyethylene terephthalate (PET). As one example, the third polymeric material can be a glass fiber reinforced nylon, e.g., 30% glass fiber reinforced, commercially available under the tradename Ultramid® B3EG6 from BASF Corporation of Florham Park, N.J. However, it should be appreciated that the third polymeric material can be any type of polymeric material without departing from the nature of the present invention.

Each of the connectors 104 include a post attachment 106 configured to engage either of the first post 98 and the second post 99 and each of the connectors 104 include a cross-member attachment 108 configured to engage either of the pair of cross-members 100 such that the connectors 104 are interchangeable with each other. In other words, each connector 104 is able to be connected with any of the posts 98, 99 and any of the cross-members 100.

In the embodiment shown in FIGS. 6 and 7, the first post 98 and the second post 99 each define a pair of slots 110 and the post attachment 106 of the connectors 104 include extensions 112 configured to extend into and engage any one of the slots 110. As such, as set forth above, each connector 104 can be engaged with either of the first post 98 and the second post 99.

With continued reference to the embodiment shown in FIGS. 6 and 7, each of the connectors 104 includes arms 114 that extend from the extension 112 for extending along one of the first and second posts 98, 99 when the connector 104 is connected to the post 98, 99. Adhesive, for example, can be disposed between the arms 114 and the post for adhering the connector 104 to the post 98, 99.

With continued reference to the embodiment shown in FIG. 7, the cross-member attachment 108 of each of the connectors 104 includes another extension 116 that extends from the arms 114 in an opposite direction from the extension 112 for engaging one of the cross-members 100. Typically, the cross-members 100 define a void 118 configured to receive the extension 112. Typically, the voids 118 of the cross-members 100 are sized and shaped to receive the extension 112 in a press-fit relationship. For example, as shown in FIG. 7, the voids 118 are rectangular and the extensions 112 are rectangular and sized to be received in the voids 118 in a press-fit relationship. Adhesive (not shown), fasteners (not shown), etc., can, for example, be used to further affix the extensions 112 and the cross-members 100. It should be appreciated that the voids 118 of the cross-member 100 and the extension 112 can have any shape suitable for a press-fit relationship without departing from the nature of the present invention.

In the embodiment shown in FIG. 8, the connectors 104 are T-shaped. In this embodiment, the connector 104 includes a main body 120 and three legs 122, 124 extending from the main body 52. Specifically, the post attachment 106 includes a pair of vertical legs 122 extending in opposite directions from the main body 52 for engaging the posts 98, 99. The cross-member attachment 108 includes a horizontal leg 124 extending from the main body 52 transversely to the vertical legs 122.

With continued reference to the embodiment shown in FIG. 8, typically, the posts 98, 99 define an aperture 126 configured to receive the vertical leg 122 and the cross-members 100 define an aperture 128 configured to receive the horizontal leg 124. Typically, the apertures 126, 128 are sized and shaped to receive the vertical legs 122 and the horizontal leg 124, respectively, in a press-fit relationship. For example, as shown in FIG. 8, the apertures 126 of the posts 98, 99 and the aperture 128 of the cross-members 100 are rectangular and the vertical legs 124 and horizontal extensions 112 are rectangular and sized to be received in the voids in a press-fit relationship. Adhesive (not shown), fasteners (not shown), etc., can, for example, be used to further affix the connectors 104 to the posts 98, 99 and the cross-members 100. It should be appreciated that the shapes of the apertures 126, 128 of the posts 98, 99 and the cross-member 100 and the shapes of the vertical legs 122 and horizontal legs 124 can have any shape without departing from the nature of the present invention.

Intermediate members 130 connect the wall frame assembly 16 to the rail 36 to connect the wall frame assembly 16 to the roof frame assembly 14. For example, FIG. 7, FIGS. 9a-b, and FIG. 10 show different embodiments of the intermediate member 130. It should be appreciated that the rail 36 shown in FIGS. 7, 9a-b, and 10 is shown as a flat bar merely for simplicity of the figures and it should be appreciated that the embodiments of FIGS. 7, 9a-b, and 10 can, for example, include the embodiments of the rails 36 shown in FIG. 3 or 4.

The intermediate members 130 are, for example, formed of a fourth polymeric material. The term “fourth” preceding the term “polymeric material” is used merely for identification purposes to distinguish the polymeric material of the intermediate members 130 from other polymeric materials referenced herein. The fourth polymeric material of the intermediate members 130, for example, can be a polyamide. The polyamide can, for example, be nylon 6, nylon 6,6, nylon 6/66, etc. The polyamide can include fiber reinforcement, e.g., can be glass filled. For example, the polyamide can be 30% glass filled. In the alternative, the fourth polymeric material of the intermediate members 130 can be, for example, polybutylene terephthalate (PBT) or polyethylene terephthalate (PET). As one example, the fourth polymeric material can be a glass fiber reinforced nylon, e.g., 30% glass fiber reinforced, commercially available under the tradename Ultramid® B3EG6 from BASF Corporation of Florham Park, N.J. However, it should be appreciated that the fourth polymeric material can be any type of polymeric material without departing from the nature of the present invention.

In the embodiment shown in FIG. 7, the intermediate member 130 is identical to the connector 104 such that the intermediate member 130 is interchangeable with the connector 104. In such an embodiment, the extension 112 engages a slot 136 in the rail and the extension 116 engages the post 98, 99.

In the embodiment shown in FIGS. 9a and 9b, the intermediate member 130 includes a terminal portion 132 sized and shaped to engage one of the apertures 126 of the post 98, 99. The terminal portion 132 and the aperture 126 are typically sized and shaped so that the terminal portion 132 and the aperture 126 are engaged in a press-fit relationship. Adhesive (not shown), fasteners (not shown), etc., can, for example, be used to further affix the intermediate member 130 to the post 98, 99. The intermediate member 130 includes a hook 134 and the rail 36 defines a slot 136 receiving the hook 134 to engage the intermediate member 130 to the rail 36.

In the embodiment shown in FIG. 10, a terminal end 138 of the intermediate member 130 extends from a main portion 140 into the aperture 126 of the post 98, 99. The terminal end 138 and the aperture 126 are typically sized and shaped so that the intermediate member 130 and the post 98, 99 are engaged in a press-fit relationship. Adhesive (not shown), fasteners (not shown), etc., can, for example, be used to further affix the intermediate member 130 to the post 98, 99. The terminal end 138 typically has reduced cross-section relative to the main portion 140

As shown in FIG. 10, at least one ear 142 extends from the main portion 140. For example, as shown in FIG. 10, two ears 142 extend from the main portion 140, however, it should be appreciated that the intermediate member can include any number of ears without departing from the nature of the present invention. Fasteners 144 extend through the ears 142 and engage the rail 36.

The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

What is claimed is:

1. A roof frame assembly for a recreational vehicle having a roof and a wall frame, said roof frame assembly comprising:
a rail extending along an axis and configured to support the roof on the wall frame;
a plurality of beams extending transversely to said rail and spaced from each other along said axis and configured to support the roof of the recreational vehicle; and
a plurality of mounting blocks spaced from each other along said axis with said mounting blocks disposed between and engaged to said rail and said beams and supporting said beams on said rail, said mounting blocks being formed of a polymeric material;
each of said mounting blocks including a rail attachment configured to engage said rail and a beam attachment configured to engage one of said beams.

2. The roof frame assembly as set forth in claim 1 wherein said mounting blocks each include a body and said beam attachment includes a protrusion extending from said body and wherein said beam defines a cavity configured to receive said protrusion.

3. The roof frame assembly as set forth in claim 2 wherein said rail attachment includes a finger extending from said body in an opposite direction from said protrusion and wherein said rail includes a corresponding finger configured to interlock with said finger of said rail attachment for mounting said mounting block to said rail.

4. The roof frame assembly as set forth in claim 3 wherein each of said mounting blocks presents a lower surface configured to abut said rail when said corresponding finger interlocks with said finger for supporting said mounting block on said rail.

5. The roof frame assembly as set forth in claim 1 further comprising a plurality of lower beams aligned with said beams along said axis and wherein said beam attachments of said mounting blocks are configured to engage said lower beams.

6. The roof frame assembly as set forth in claim 1 further comprising a plurality of lower beams aligned with said beams along said axis and wherein mounting blocks each include a body with said beam attachment include a protrusion extending from said body configured to engage said beam and a lower protrusion extending from said body configured to engage said lower beam.

7. The roof frame assembly as set forth in claim 1 wherein said rail includes a plurality of segments spaced from each other and extending along said axis with said mounting blocks disposed along said axis between said segments.

8. The roof frame assembly as set forth in claim 1 further comprising a second rail spaced from said rail and extending in parallel with said rail, said beams extending between said rail and said second rail.

9. The roof frame assembly as set forth in claim 1 wherein said rail is formed of a second polymeric material.

10. The roof frame assembly as set forth in claim 1 wherein said rail includes a bottom end for abutting the wall frame of the recreational vehicle, an inwardly facing end presenting said beam attachment, and a rounded exterior surface curving from said inwardly facing end to said bottom end.

11. The roof frame assembly as set forth in claim 10 wherein said rail is formed of a second polymeric material.

12. A roof frame assembly for a recreational vehicle, said roof frame assembly comprising:
a rail extending along an axis;
a plurality of mounting blocks spaced from each other along said axis with said mounting blocks configured to engage said rail for supporting a plurality of beams extending transversely to said rail to support a roof of the recreational vehicle;
said mounting blocks being formed of a first polymeric material and said rail being formed of a second polymeric material;
each of said mounting blocks including a rail attachment configured to engage said rail and a beam attachment configured to engage one of the beams.
said rail includes a bottom end for abutting a wall of the recreational vehicle, an inwardly facing end presenting said beam attachment, and a rounded exterior surface curving from said inwardly facing end to said bottom end.

13. The roof frame assembly as set forth in claim 12 wherein said mounting blocks each include a body and said beam attachment includes a protrusion extending from said body for engaging said beam.

14. The roof frame assembly as set forth in claim 13 wherein said rail attachment includes a finger extending from said body in an opposite direction from said protrusion and wherein said rail includes a corresponding finger configured to interlock with said finger of said rail attachment for mounting said mounting block to said rail.

15. A wall frame assembly for supporting a wall of a recreational vehicle, said wall frame assembly comprising:
a first post and a second post spaced from each other for extending vertically between a floor and a roof of the recreational vehicle to support the wall of the recreational vehicle;
a pair of cross-members spaced from each other and each extending between said first post and said second post to define a window opening;
a pair of connectors spaced from each other along said first post and disposed between and connecting said pair of cross-members and said first post and a pair of connectors spaced from each other along said second post with said connectors disposed between and connecting said pair of cross-members and said second post;
each of said connectors including a post attachment configured to engage either of said first post and said second post and each of said connectors including a cross-member attachment configured to engage either of said pair of cross-members such that said connectors are interchangeable with each other.

16. The wall frame assembly as set forth in claim 15 wherein said first post and said second post each define a pair of slots and wherein said post attachment of said connectors include extensions configured to extend into and engage any one of said slots.

17. The wall frame assembly as set forth in claim 16 wherein each of said connectors includes arms that extend from said extension for extending along one of said first and second posts when said connector is connected to said one of said first and second posts.

18. The wall frame assembly as set forth in claim 17 further comprising adhesive disposed between said arms and said one of said first and second posts for adhering said connector to said one of said first and second posts.

19. The wall frame assembly as set forth in claim 17 wherein said cross-member attachment of each of said connectors includes another extension that extends from said arms in an opposite direction from said extension for engaging one of said cross-members.

20. The wall frame assembly as set forth in claim 15 wherein said connectors are formed of a polymeric material.
